(19) United States
(12) Patent Application Publication
(10) Pub. No.: US 2019/0182505 A1
(43) Pub. Date: Jun. 13, 2019

(54) METHODS AND APPARATUSES OF PREDICTOR-BASED PARTITION IN VIDEO PROCESSING SYSTEM

(71) Applicant: MEDIATEK INC., Hsin -Chu (TW)

(72) Inventors: Tzu-Der CHUANG, Zhubei City, Hsinchu County (TW); Ching-Yeh CHEN, Taipei City (TW); Yu-Wen HUANG, Taipei City (TW)

(21) Appl. No.: 16/321,907

(22) PCT Filed: Aug. 10, 2017
(86) PCT No.: PCT/CN2017/096715

§ 371 Date: Jan. 30, 2019

Related U.S. Application Data
(60) Provisional application No. 62/374,059, filed on Aug. 12, 2016.

(51) Int. Cl. H04N 19/52; H04N 19/119; H04N 19/96; H04N 19/70; H04N 19/176

(52) U.S. Cl. CPC H04N 19/52; H04N 19/119; H04N 19/176; H04N 19/70; H04N 19/96

(57) ABSTRACT

Video processing methods and apparatuses for encoding or decoding video data comprise receiving input data associated with a current block in a current picture, determining a first reference block, splitting the current block into multiple partitions according to predicted textures of the first reference block, and separately predicting or compensating each partition of the current block to generate predicted regions or compensated regions. The current block is encoded according to the predicted regions and original data of the current block or the current block is decoded by reconstructing the current block according to the compensated regions of the current block.

### CROSS REFERENCE TO RELATED APPLICATIONS

The present invention claims priority to U.S. Provisional Patent Application Ser. No. 62/374,059, filed on Aug. 12, 2016, entitled “Methods of predictor-based partition”. The U.S. Provisional patent application is hereby incorporated by reference in its entirety.

### FIELD OF THE INVENTION

The present invention relates to video data processing methods and apparatuses for video encoding or video decoding. In particular, the present invention relates to video data processing methods and apparatuses encode or decode video data by splitting blocks according to predictor-based partition.

### BACKGROUND AND RELATED ART

The High-Efficiency Video Coding (HEVC) standard is the latest video coding standard developed by the Joint Collaborative Team on Video Coding (JCT-VC) group of video coding experts from ITU-T Study Group. The HEVC standard relies on a block-based coding structure which divides each slice into multiple Coding Tree Units (CTUs). In the HEVC main profile, the minimum and the maximum sizes of a CTU are specified by syntax elements signaled in the Sequence Parameter Set (SPS) of an encoded video bitstream. The CTUs in a slice are processed according to a raster scan order. Each CTU is further recursively divided into one or more Coding Units (CUs) according to a quadtree partitioning method to adapt to various local characteristics. The CU size is restricted to be less than or equal to a minimum allowed CU size, which is also specified in the SPS. An example of the quadtree block partitioning structure for a CTU is illustrated in FIG. 1, where the solid lines indicate CU boundaries in the CTU 100.

The prediction decision is made at the CU level, where each CU is either coded by Inter picture prediction or Intra picture prediction. Once the splitting of CU hierarchical tree is done, each CU is subject to further split into one or more Prediction Units (PUs) according to a PU partition type for prediction. FIG. 2 shows eight PU partition types defined in the HEVC standard. Each CU is split into one, two, or four PUs according to one of the eight PU partition types shown in FIG. 2. The PU works as a basic representative block for sharing the prediction information as the same prediction process is applied to all pixels in the PU and prediction relevant information is conveying to the decoder on a PU basis. After obtaining a residual signal generated by the prediction process, residual data of the residual signal belong to a CU is split into one or more Transform Units (TUs) according to another quadtree block partitioning structure for transforming the residual data into transform coefficients for compact data representation. The dotted lines in FIG. 1 indicate TU boundaries in the CTU 100. The TU is a basic representative block for applying transform and quantization on the residual signal. For each TU, a transform matrix having the same size as the TU is applied to the residual signal to generate the transform coefficients, and these transform coefficients are quantized and conveyed to the decoder on a TU basis.

The terms Coding Tree Block (CTB), Coding block (CB), Prediction Block (PB), and Transform Block (TB) are defined to specify two-dimensional sample array of one color component associated with the CTU, CU, PU, and TU respectively. For example, a CTU consists of one luminance (luma) CTB, two chrominance (chroma) CTBs, and its associated syntax elements. In the HEVC system, the same quadtree block partitioning structure is generally applied to both luma and chroma components unless a minimum size for chroma block is reached.

An alternative partitioning method is called binary tree block partitioning, where a block is recursively split into two smaller blocks. A simplest and most efficient binary tree partitioning method only allows symmetrical horizontal splitting and symmetrical vertical splitting. For a given block of size M×N, a flag indicates whether the block is split into two smaller blocks, if the flag is true, another syntax element is signaled to indicate which splitting type is used. The size of the two smaller blocks is M×N/2 if symmetrical horizontal splitting is used; otherwise the size is M/2×N if symmetrical vertical splitting is used. Although the binary tree partitioning method supports more partition shapes and thus is more flexible than the quadtree partitioning method, the coding complexity and signaling overhead increase for selecting the best partition shape among all possible partition shapes. A combined partitioning method called Quad-Tree-Binary-Tree (QTBT) structure combines a quadtree partitioning method with a binary tree partitioning method, which balances the coding efficiency and the coding complexity of the two partitioning methods. An exemplary QTBT structure is shown in FIG. 3A, where a large block such as a CTU is firstly partitioned by a quadtree partitioning method then a binary tree partitioning method. FIG. 3A illustrates an example of block partitioning structure according to the QTBT partitioning method and FIG. 3B illustrates a coding tree diagram for the QTBT block partitioning structure shown in FIG. 3A. The solid lines in FIGS. 3A and 3B indicate quadtree splitting while the dotted lines indicate binary tree splitting. In each splitting (i.e., non-leaf) node of the binary tree structure, one flag indicates which splitting type (symmetric horizontal splitting or symmetric vertical splitting) is used, 0 indicates horizontal splitting and 1 indicates vertical splitting. The QTBT partitioning method may be used to split a slice into CTUs, a CTU into CUs, a CU into PUs, or a CU into TUs. In one embodiment, it is possible to simplify the partitioning process by omitting the splitting from CU to PU and from CU to TU, as the leaf nodes of a binary tree block partitioning structure is the basic representative block for both prediction and transform coding. For example, the QTBT structure shown in FIG. 3A splits the large block, a CTU, into multiple smaller blocks, CUs, and these smaller blocks are processed by prediction and transform coding without further splitting.

The QTBT partition method is applied individually to luma and chroma components for I slices, which means a luma CTB has its own QTBT-structured block partitioning, and the two corresponding chroma CTBs have another QTBT-structured block partitioning, in another embodiment, each of the two chroma CTBs may have individual QTBT-structured block partitioning. The QTBT partition method is applied simultaneously to both the luma and chroma components for P and B slices.

Another partitioning method called triple tree partitioning method is used to capture objects which locate in the block center while quadtree partitioning method and binary tree partitioning method always split along the block center. Two exemplary triple tree partition types include horizontal center-side triple tree partitioning and vertical center-side triple tree partitioning. The triple tree partitioning method may provide capability to faster localize small objects along block boundaries, by allowing one-quarter partitioning vertically or horizontally.

### BRIEF SUMMARY OF THE INVENTION

Methods and apparatuses of processing video data in a video coding system encode or decode a current block in a current picture by splitting the current block according to a predictor-based partition method. The video coding system receives input data associated with the current block, determines a first reference block for the current block, and splits the current block into partitions according to predicted textures of the first reference block. Each partition in the current block is separately predicted or compensated to generate predicted regions or compensated regions for the current block. The current block is encoded according to the predicted regions and original data of the current block or the current block is decoded by reconstructing the current block according to the compensated regions of the current block.

An embodiment of the current block is predicted or compensated according to a prediction mode selected by a mode syntax. The mode syntax may be signaled at a current-block-level for the current block or the mode syntax may be signaled at a partition-level for each partition in the current block. For example, the mode syntax may be signaled at CU-level or PU level when the predictor-based partition method is applied to split a CU into PUs. In some embodiments, the first reference block for splitting the current block is also used to predict one partition of the current block. A first compensation region syntax is signaled to determine which partition of the current block is predicted by the first reference block. In another embodiment, the first reference block is only used to split the current block into multiple partitions. The first reference block may be determined according to a first motion vector (MV) or a first Intra prediction mode, and the first MV may be coded using Advance Motion Vector Prediction (AMVP) mode or Merge mode.

In some embodiments, a second reference block is determined for predicting one partition of the current block. The second reference block may be determined according to a second MV or a second Intra prediction mode, and the second MV may be coded using AMVP mode or Merge mode.

The current block is split by applying a region partition method to the first reference block. Some examples of the region partition method include applying an edge detection filter to the first reference block to find a dominate edge, applying K-means partition method to split the current block according to pixel intensities of the first reference block, and applying an optical flow method to partition the current block according to pixel-based motions of the first reference block. If there are more than one partition results, a second syntax can be signaled to determine which partition result is used.

After generating the predicted regions or the compensated regions of the current block, some embodiments of the video coding system process a boundary of the predicted regions or compensated regions to reduce artifacts at the boundary by changing pixel values at the boundary of the predicted regions or compensated regions. If the current block is Inter predicted, the current block is divided into N×N sub-blocks for reference MV storing. Some embodiments of reference MV storing store a reference MV for each sub-block according to a predefined reference MV storing position. One or more stored reference MVs of the current block are referenced by another block in the current picture or referenced by a block in another picture. In one embodiment, the reference MV for each sub-block is stored further according to a first compensation region position flag, for example, the first compensation region position flag indicates whether the first reference block is used to predicted a region covering a top-left pixel of the current block.

Aspects of the disclosure further provide an apparatus for the video coding system encoding or decoding video data according to a predictor-based partition method. The apparatus receives input data associated with a current block in a current picture, determines a first reference block, splits the current block into multiple partitions according to predicted textures of the first reference block, and separately predicts or compensates each partition in the current block to generate predicted regions or compensated regions, and encode the current block according to the predicted regions or decode the current block according to the compensated regions.

Aspects of the disclosure further provide a non-transitory computer readable medium storing program instructions for causing a processing circuit of an apparatus to perform video coding process according to a predictor-based partition method. Other aspects and features of the invention will become apparent to those with ordinary skill in the art upon review of the following descriptions of specific embodiments.

### BRIEF DESCRIPTION OF THE DRAWINGS

Various embodiments of this disclosure that are proposed as examples will be described in detail with reference to the following figures, wherein like numerals reference like elements, and wherein:

FIG. 1 illustrates an exemplary coding tree for splitting a Coding Tree Unit (CTU) into Coding Units (CUs) and splitting each CU into one or more Transform Units (TUs) according to the HEVC standard.

FIG. 2 illustrates eight different Prediction Unit (PU) partition types splitting a CU into one or more PUs according to the HEVC standard.

FIG. 3A illustrates an exemplary block partitioning structure of a Quad-Tree-Binary-Tree (QTBT) partitioning method.

FIG. 3B illustrates a coding tree structure corresponding to the block partitioning structure of FIG. 3A.

FIG. 4 illustrates an example of CU partitions according to a quadtree partitioning method for a circular object.

FIG. 5A illustrates an example of determining one dominate edge according to the predicted textures of a reference block.

FIG. 5B illustrates Region-A covering a top-left pixel of the current block divided by the dominate edge determined in FIG. 5A.

FIG. 5C illustrates Region-B of the current block divided by the dominate edge determined in FIG. 5A.

FIG. 6 is a flowchart illustrating a video processing method with predictor-based partition according to an embodiment of the present invention.

FIG. 7A shows exemplary predefined reference MV storing position with a 45-degree partition.

FIG. 7B shows exemplary predefined reference MV storing position with a 135-degree partition.

FIG. 8 illustrates an exemplary system block diagram for a video encoding system incorporating the video data processing method according to embodiments of the present invention.

FIG. 9 illustrates an exemplary system block diagram for a video decoding system incorporating the video data processing method according to embodiments of the present invention.

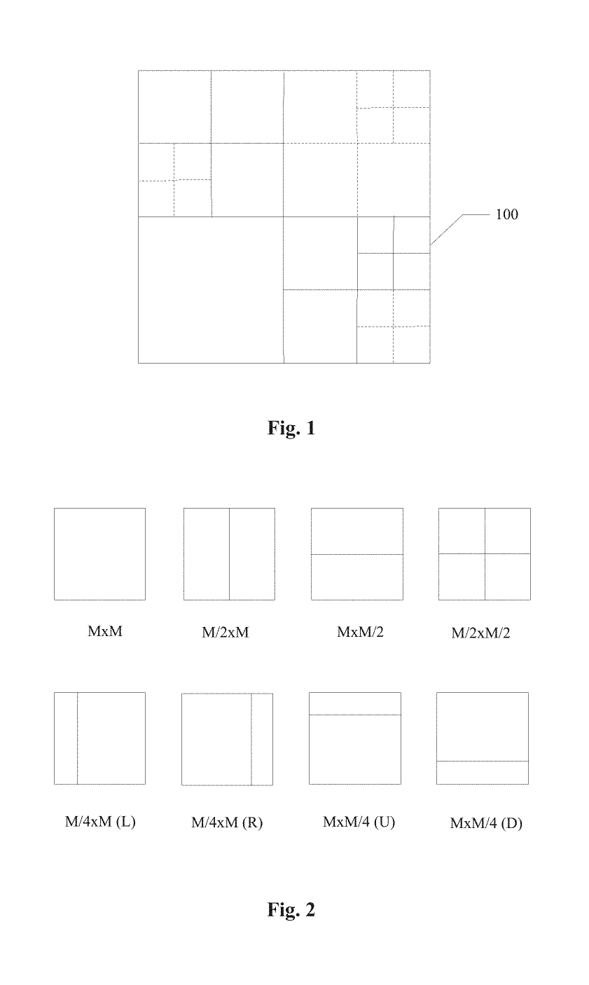

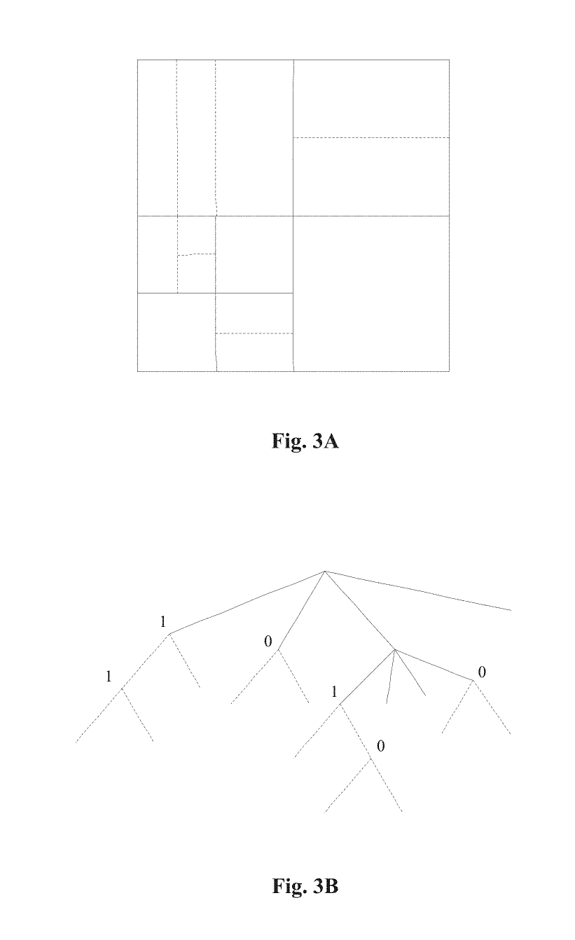

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention.

Reference throughout this specification to “an embodiment”, “some embodiments”, or similar language means that a particular feature, structure, or characteristic described in connection with the embodiments may be included in at least one embodiment of the present invention. Thus, appearances of the phrases “in an embodiment” or “in some embodiments” in various places throughout this specification are not necessarily all referring to the same embodiment, these embodiments can be implemented individually or in conjunction with one or more other embodiments. Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention.

There is noticeable throughput degradation when small coding block sizes are used to encode video data as compared to large coding block sizes as the total number of coding blocks increases when smaller coding block sizes are selected. Syntax overheads increase with the total number of coding blocks, and the coding efficiency decreases with increasing overheads. Small coding blocks are typically used to code complicated textures or boundaries of moving objects. For intra coded frames or intra coded Coding Units (CUs), it is observed that CU boundaries usually depend on texture intensities of the image, that is smaller CUs are used at regions with complicated texture intensities, while larger CUs are used at regions with smooth texture intensities. For inter coded CUs, even the motion of moving objects is constant, it is observed that CU boundaries typically depend on object boundaries of the moving objects, which means smaller CUs are used to encode the object boundaries of the moving objects. Although various block partitioning methods were proposed to split a video picture into blocks for video coding, the resulting blocks of the various block partitioning methods are square or rectangular blocks. The square and rectangular shapes are not the best shape to predict boundaries of most moving objects, so the block partitioning method splits regions covering the boundaries into many small blocks to better fit the boundaries of the moving objects.

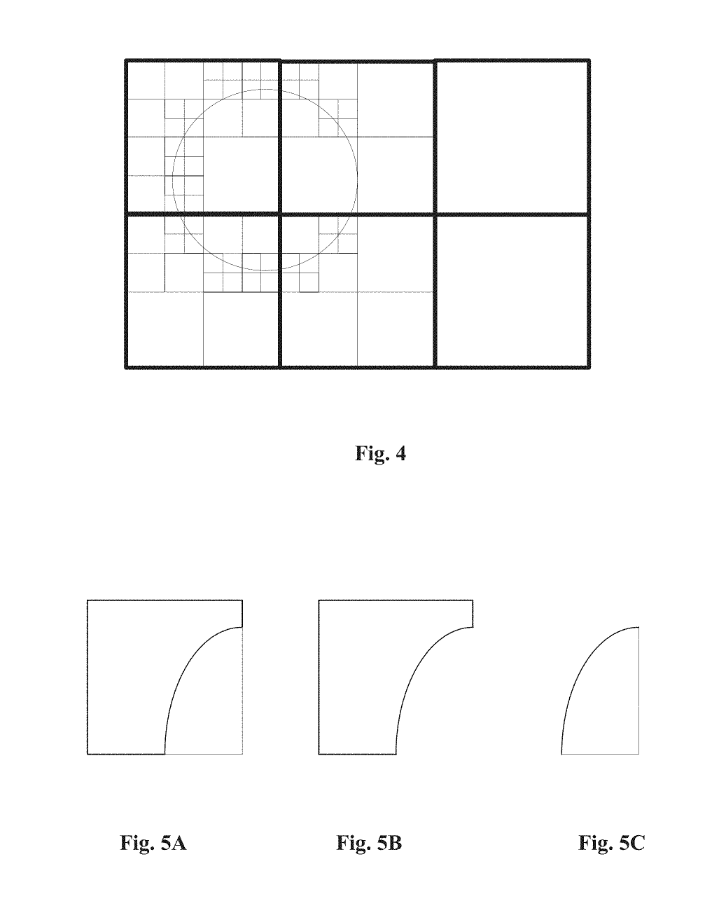

FIG. 4 illustrates an example of CU partitions split according to the quadtree block partitioning method for a circular object. The circular object in FIG. 4 is a moving object which has a different motion with its background. Smaller CUs and PU partitions are used to encode the texture of the object boundary as shown in FIG. 4. Although the Merge mode may be used to reduce the syntax overheads of motion information, a lot of syntaxes such as the Merge flags are still required to be signaled for the finer granularity partitions. Compared to the quadtree partitioning method, other partitioning methods such as QTBT and triple tree partitioning methods offer greater flexibility in block partitioning, however, these partitioning methods still split the blocks with straight lines to produce rectangular blocks. As previously described, small rectangular blocks are used to encode non-straight object boundaries of the moving objects when the partitioning method such as QTBT or triple tree partitioning method is used. Embodiments of the present invention provide a partitioning method capable of splitting a block with one or more curve lines which better fits the object boundaries.

Predictor-Based Partition

Embodiments of the present invention derive block partitions of a current block based on a predictor-based partition method. The predictor-based partition method splits the current block according to predicted textures of a reference block. The reference block may be Inter predicted predictor block determined by a motion vector or the reference block may be Intra predicted predictor block determined by an Intra prediction mode. In some embodiments, the predictor-based partition method is applied to split a current block, such as a current Coding Unit (CU), by signaling a first motion vector to derive a first reference block for the current CU. The current CU is first split into two or more partitions, such as Prediction Units (PUs), according to predicted textures of the first reference block. By applying a predefined region partition method to the predicted textures of the first reference block, the first reference block is partitioned into multiple regions and the current CU is split into PUs according to the partitioning of the first reference block. An example of the predefined region partition method includes applying an edge detection filter to the predicted textures of the first reference block to determine one or more dominate edge in the first reference block. FIG. 5A illustrates an example of determining a dominate edge in a first reference block. In an example, the dominate edge of the first reference block divides the current block into two partitions as shown in FIG. 5B and FIG. 5C. FIG. 5B illustrates Region-A of the current block covering a top-left pixel of the current block and FIG. 5C illustrates Region-B of the current block. Each of Region-A and Region-B is predicted or compensated separately, where both partitions may be Inter predicted or Intra predicted, and it is also possible for one partition to be Inter predicted while another partition to be Intra predicted. In an embodiment, one partition is predicted by a first reference block and another partition is predicted by a second reference block to generate a first predicted region or a first compensated region and a second predicted region or a second compensated region respectively. The first reference block is located by a first MV or derived by a first Intra prediction mode, whereas a second reference block is located by a second MV or derived by a second Intra prediction mode. By applying the predictor-based partitioning method as shown in FIG. 5A, the upper-left part of the circular object in FIG. 4 may be predicted by one single CU, where the CU is partitioned into two PUs as shown in FIGS. 5B and 5C.

The first reference block used to determine the partition boundary of the current block may be used to predict or compensate one or none of the partitions in the current block. For example, the first reference block is only used to split the current block, in another example, the first reference block is also used to predict a predefined region or a selected region of the current block. In one example of using the first reference block to predict a predefined region, the first reference block is always used to split the current block and predict the partition covering a top-left pixel of the current block; in another example of using the first reference block to predict a selected region, one flag is signaled to indicate whether a partition covering the top-left pixel or any pre-defined pixel of the current block is predicted by the first reference block. In other words, the flag indicates whether a first predicted region predicted by the first reference block covers the pre-defined pixel such as the top-left pixel of the current block. In one embodiment, a first reference block located by a first MV is used to determine a partition boundary for splitting a current block as shown in FIG. 5A, and a syntax (e.g., a first_compensation_region_position_flag) is used to indicate whether a first compensated region derived by the first reference block is region-A in FIG. 5B or region-B in FIG. 5C. In other words, which partition of the current block is predicted by the first reference block is determined by the flag first_compensation_region_position_flag. For example, the flag first_compensation_region_position_flag equals to 1 means the first compensation region covers the top-left pixel of the current block while the flag equals to 0 means the first compensation region does not cover the top-left pixel of the current block. Region-A in FIG. 5B is predicted by the first reference block while Region-B in FIG. 5C is predicted by a second reference block if the flag equals to 1; Region-B in FIG. 5C is predicted by the first reference block and Region-A in FIG. 5B is predicted by the second reference block if the flag equals to 0.

In some embodiments of the predictor-based partition method, more than one reference blocks are used to split the current block into multiple partitions. For example, a first reference block is used to split the current block into two partitions then a second reference block is used to further split one of the two partitions into two smaller partitions, or the second reference block is used to further split the current block into four or more partitions.

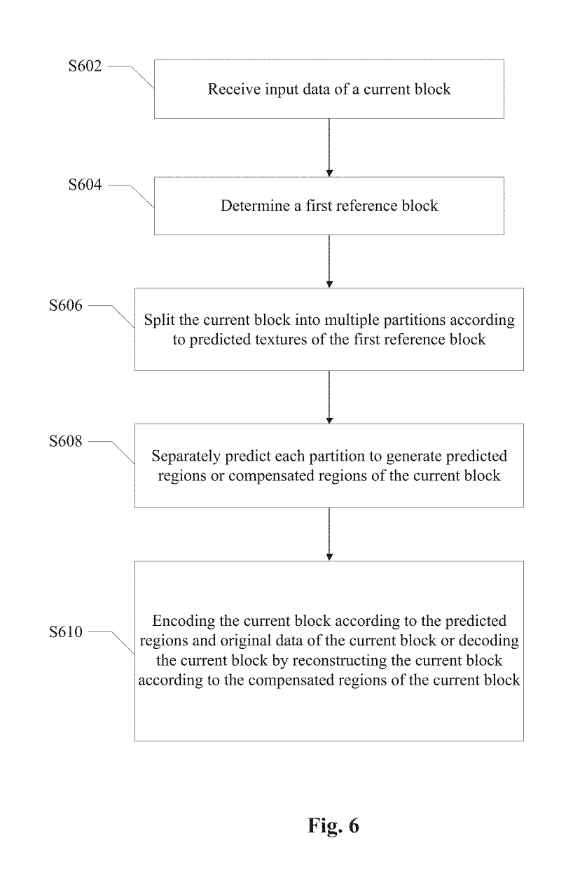

FIG. 6 is a flowchart illustrating a video processing method with predictor-based partition according to an embodiment of the present invention. A current picture is first partitioned into blocks according to a partitioning method and each resulting block is further partitioned based on an embodiment of the predictor-based partition method. In step S602, a video encoder or a video decoder receives input data associated with a current block in a current picture. A first reference block is determined for the current block in step S604. For example, the first reference block is located according to a first motion vector (MV) or the first reference block is derived according to a first Intra prediction mode. The current block is split into two or more partitions according to predicted texture of the first reference block in step S606. Each partition of the current block is separately predicted or compensated to generate predicted regions or compensated regions in step S608. For example, the partitions are separately predicted or compensated by multiple reference blocks located by multiple motion vectors. In step S610, the video encoder encodes the current block according to the predicted regions and original data of the current block; or the video decoder decodes the current block by reconstructing the current block according to the compensated regions of the current block.

Region Partition Method

Some embodiments of the present invention partition a current block by applying an edge detection filter to predicted textures of a reference block. For example, the Sobel edge detector or Canny edge detector is used to locate one or more dominate edges that can split the current block into two or more partitions. In some other embodiments, a K-means partition method is applied to the reference block to split the current block. The K-means partition method divides the reference block into irregularly shaped spatial partitions based on K-means clustering of pixel intensities of the reference block. The K-means clustering aims to partition the pixel intensities of the reference block into K clusters by minimizing a total intra-cluster variation, in which pixel intensities within a cluster are as similar as possible, whereas pixel intensities from different clusters are as dissimilar as possible. Another embodiment of the region partition method uses optical flow to determine pixel-based motions within the reference block. The reference block can be divided into multiple regions according to the pixel-based motions of the reference block, where pixels with similar motions belong to the same region, and the current block is split into partitions according to the divided regions of the reference block. In some embodiments, the region partition method might divide the current block into more than one partition results, for example, finding two or more dominate edges that can split the current block into two or more partitions. If more than one partition results are generated, one syntax is signaled to indicate which partition result (for example, which dominate edge) is used to code the current block.

Region Boundary Processing

In some embodiments, after obtaining the predicted regions or compensated regions of the current block according to the reference blocks, the predicted regions or compensated regions of the current block are further processed to reduce or remove the artifact at the region boundary of the predicted regions or compensated regions. Pixel values at the region boundary of the compensated regions may be modified to reduce the artifact at the boundary. An example of the region boundary processing blends the region boundary by applying overlapped motion compensation or overlapped intra prediction. Along the region boundary of two compensated regions, a predefined range of pixels are predicted by averaging or weighting predicted pixels of the two predicted regions or two compensated regions. The predefined range of pixels at the region boundary may be two or four pixels.

Mode Signaling and MV Coding

One or more prediction modes for a current block can be selected by one or more mode syntaxes. The mode syntax can be signaled in current-block-level (e.g. CU-level) or partition-level (e.g. PU-level). For example, all PUs in a current CU are coded using the same prediction mode when a mode syntax is signaled in CU-level, and the PUs in the current CU may be coded using different prediction modes when two or more mode syntaxes for the current CU are signaled in either CU-level or PU-level. Some embodiments of the predictor-based partition method first select one or more prediction modes for a current block, obtain a first reference block according to a predefined mode or a selected prediction mode, and determine region partitioning for the current block according to predicted texture of the first reference block. Each of the partitions in the current block is then separately predicted or compensated according to a corresponding selected prediction mode. Some other embodiments of the predictor-based partition method first partition a current block into multiple partitions according to a first reference block, then select one or more prediction modes for predicting or compensating the partitions in the current block. In one example, the current block is a current CU, the partitions in the current CU are PUs, and the prediction mode is signaled in PU level.

All the partitions in the current block may be restricted to be predicted or compensated using the same prediction mode according to one embodiment. For example, if the prediction mode for the current block is Inter prediction, two or more partitions split from the current block are predicted or compensated by reference blocks pointed by motion vectors, if the prediction mode for the current block is Intra prediction, two or more partitions split from the current block are predicted by reference blocks derived according to an Intra prediction mode. According to another embodiment, each partition in the current block is allowed to select an individual prediction mode, so the current block may be predicted by different prediction modes.

The following examples demonstrate the mode signaling and MV coding method for a current block predicted by Inter prediction, where the current block is a CU and is partitioned into two PUs, and each PU is predicted or compensated according to a motion vector (MV). In a first method, two MVs are coded using Advance Motion Vector Prediction (AMVP) mode, in a second method, the first MV is coded in Merge mode and the second MV is coded in AMVP mode, in a third method, the first MV is coded in AMVP mode and the second MV is coded in Merge mode, and in a fourth method, both the MVs are coded in Merge mode.

In the first method, the prediction mode for each PU in a current CU may be signaled in the PU-level and signaled after the syntax Inter direction (interDir). If bi-directional prediction is used, the prediction mode may be separately signaled for List 0 and List 1. In the second method, a reference picture index and MV are signaled for the second MV while a Merge index is signaled for the first MV. In one embodiment, the reference picture index of the second MV is the same as the reference picture index of the first MV, only the MV including horizontal component MVx and vertical component MVy are signaled for the second MV. In the third method, a reference picture index and MV are signaled for the first MV while a Merge index is signaled for the second MV. In the fourth method, two Merge indices are signaled for deriving the first MV and the second MV according to an embodiment. In another embodiment, only one Merge index is required. If there are two MVs in the selected Merge candidate derived by the Merge index, one of the MVs is used as the first MV while the other MV is used as the second MV. If there is only one MV in the selected Merge candidate derived by the Merge index, the only MV is used as the first MV and the second MV is derived by extending the first MV to other reference frames.

MV Referencing

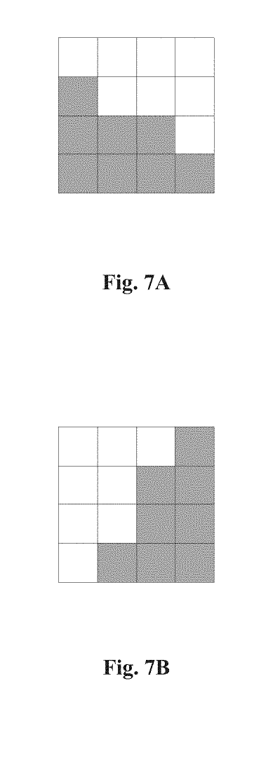

The prediction-based partition method splits a current block into multiple partitions according to predicted textures of a first reference block. When the current block is coded using Inter prediction, representative MVs of the current block are stored for MV referencing by spatial or temporal neighboring blocks of the current block. For example, the representative MVs of a current block are used for constructing a Motion Vector Predictor (MVP) candidate list or Merge candidate list for a neighboring block of the current block. The current block is divided into multiple N×N sub-blocks for reference MV storing, and a representative MV is stored for each N×N sub-block, where an example of N is 4. In one embodiment of reference MV storing, the stored representative MV for each sub-block is the MV that corresponds to most pixels in the sub-block. For example, the current block includes a first region compensated by a first MV and a second region compensated by a second MV, if most pixels in a sub-block belong to the first region, the representative MV of this sub-block is the first MV. In another embodiment, the stored MV is the center MV of each sub-block. For example, if the center pixel in a sub-block belongs to the first region, the representative MV of this sub-block is the first MV. In another embodiment of reference MV storing, the reference MV storing position is predefined. FIG. 7A and FIG. 7B illustrate two examples of the predefined reference MV storing position, where FIG. 7A shows sub-blocks in a current block are divided by a predefined 45-degree partition into two regions, and FIG. 7B shows sub-blocks in a current block are divided by a predefined 135-degree partition into two regions. The white sub-blocks in FIG. 7A and FIG. 7B belong to a first region as the first region is defined to include a top-left pixel of the current block, and the gray sub-blocks in FIG. 7A and FIG. 7B belong to a second region. One of the MVs of the current block is the representative MV of the sub-blocks in the first region and another MV of the current block is the representative MV of the sub-blocks in the second region. A flag may be signaled to select which MV is stored for the first region covering the top-left pixel of the current block. For example, a first MV is stored for sub-blocks in the first region when a flag, first_compensation_region_position_flag, is zero, whereas the first MV is stored for sub-blocks in the second region when the flag is one.

One advantage to store the reference MVs for a current block coded with predictor-based partition according to a predefined reference MV storing position is to allow the memory controller to pre-fetch reference data according to the stored reference MV without waiting for the derivation of the real block partitioning of the current block. The memory controller may pre-fetch the reference data once the entropy decoder decodes motion vector information of the current block, and this pre-fetch process can be performed at the same time during inverse quantization and inverse transform. The predefined reference MV storing position is only used to generate MVP or Merge candidate list for neighboring blocks, since the real block partitioning is derived during motion compensation, the deblocking filter applied after motion compensation uses MVs stored according to the real block partitioning for deblocking computation.

PMVD Bandwidth Reduction

A pattern-based MV derivation (PMVD) method was proposed to reduce the MV signaling overhead. The PMVD method includes bilateral matching merge mode and template matching merge mode, and a flag FRUC_merge_mode is signaled to indicate which mode is selected. In the PMVD method, a new temporal MVP called temporal derived MVP is derived by scanning all MVs in all reference frames. Each List 0 MV in List 0 reference frames is scaled to point to the current frame in order to derive the List 0 temporal derived MVP. A 4×4 block that pointed by this scaled MV in the current frame is the target current block. The MV is further scaled to point to a reference picture that the reference frame index refIdx is equal to 0 in List 0 for the target current block. The further scaled MV is stored in the List 0 MV field for the target current block.

For bilateral matching merge mode, two-stage matching is applied. The first stage is PU-level matching, and the second stage is sub-PU-level matching. In the first stage, several starting MVs in List 0 and List 1 are selected respectively, and these MVs include the MVs from Merge candidates and MVs from temporal derived MVPs. Two different starting MV sets are generated for the two lists. For each MV in one list, a MV pair is generated by composing of this MV and a mirrored MV that is derived by scaling the MV to the other list. For each MV pair, two reference blocks are compensated by using this MV pair. The sum of absolutely differences (SAD) of these two blocks is then calculated, and the MV pair with the smallest SAD is the best MV pair. A diamond search is performed to refine the best MV pair. The refinement precision is ⅛-pel. The refinement search range is restricted within ±8 pixel. The final MV pair is the PU-level derived MV pair.

In the second stage, the current PU is divided into sub-PUs. The depth of the sub-PU is signaled in Sequence Parameter Set (SPS). An example of the minimum sub-PU size is 4×4 block. For each sub-PU, several starting MVs in List 0 and List 1 are selected, which includes MVs of the PU-level derived MV, zero MV, HEVC defined collocated Temporal Motion Vector Predictor (TMVP) of the current sub-PU and bottom-right block, temporal derived MVP of the current sub-PU, and MVs of the left and above PUs or sub-PUs. By using a similar mechanism in the PU-level matching, the best MV pair for the sub-PU-level is determined. A diamond search is performed to refine the best MV pair. Motion compensation for this sub-PU is performed to generate the predictor for this sub-PU.

For the template matching merge mode, reconstructed pixels of above four rows and left four columns of a current block are used to form a template. The template matching is performed to find the best matched template in a reference frame with its corresponding MV. Two-stage matching is also applied for template matching merge mode, in the PU-level matching, several starting MVs in List 0 and List 1 are selected respectively. These MVs include MVs from Merge candidates and MVs from temporal derived MVPs. Two different starting MV sets are generated for the two lists. For each MV in one list, the SAD cost of the template with the MV is calculated, and the MV with the smallest SAD cost is the best MV. A diamond search is performed to refine the best MV. The refinement precision is ⅛-pel, and the refinement search range is restricted within ±8 pixel. The final refined MV is the PU-level derived MV. The MVs in the two lists are generated independently. For the second stage, sub-PU-level matching, the current PU is divided into sub-PUs. The depth of the sub-PU is signaled in SPS, and the minimum sub-PU size may be 4×4 block. For each sub-PU at left or top PU boundaries, several starting MVs in List 0 and List 1 are selected, which includes MVs of PU-level derived MV, zero MV, HEVC defined collocated TMVP of the current sub-PU and bottom-right block, temporal derived MVP of the current sub-PU, and MVs of left and above PUs or sub-PUs. By using the similar mechanism in the PU-level matching, the best MV pair for the sub-PU is selected. The diamond search is performed to refine the best MV pair. Motion compensation for this sub-PU is performed to generate the predictor for this sub-PU. For PUs not at left or top PU boundaries, the sub-PU-level matching is not applied, and the corresponding MVs are set equal to the final MVs in the first stage.

In the PMVD method, the worst case bandwidth is for small size blocks. In order to reduce the worst case bandwidth required for the PMVD method, an embodiment of PMVD bandwidth reduction changes the refinement range according to the block size. For example, for a block with block area smaller than or equal to 256, the refinement range is reduced to ±N, where N can be 4 according to one embodiment. Embodiments of the present invention determine the refinement search range for the PMVD method according to the block size.

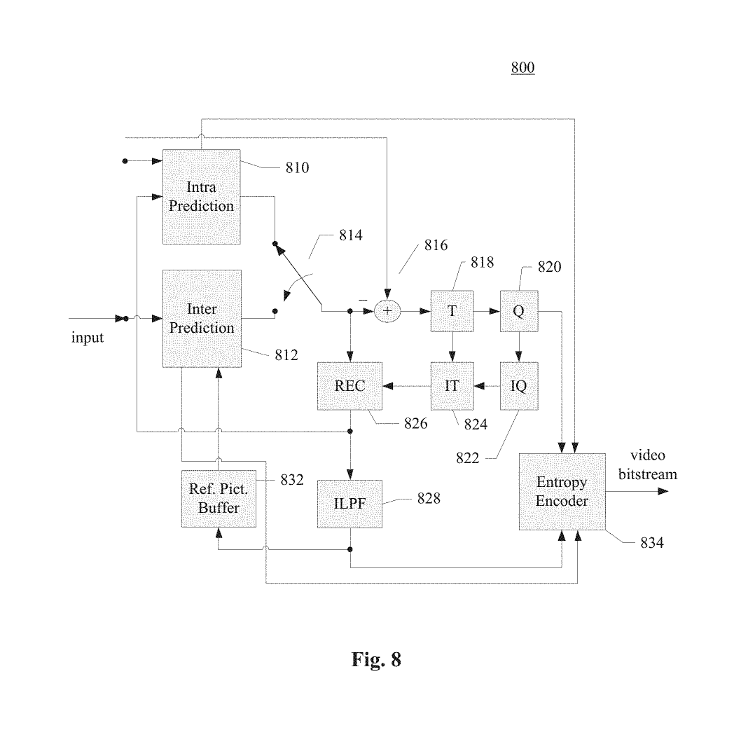

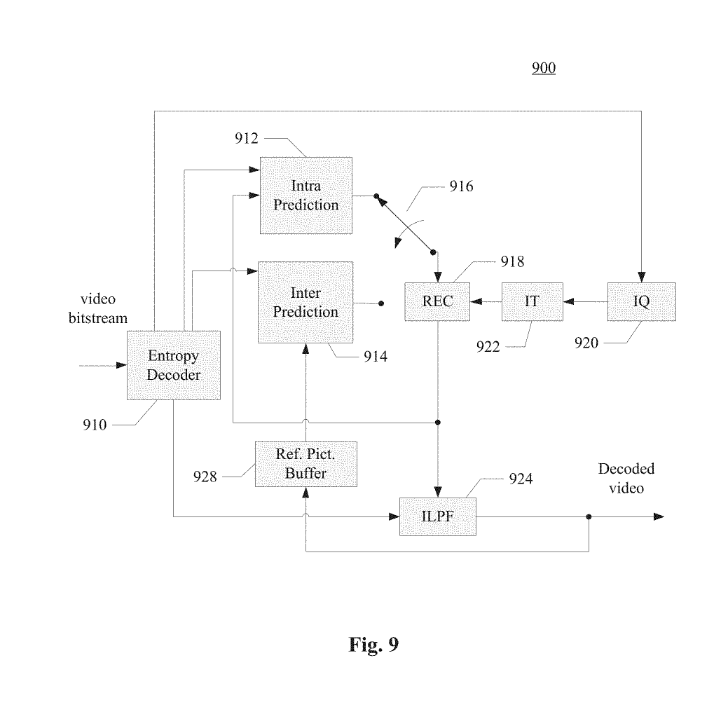

FIG. 8 illustrates an exemplary system block diagram for a Video Encoder 800 implementing embodiments of the present invention. A current picture is processed by the Video Encoder 800 in block-based, and a current block coded using predictor-based partition is split into multiple partitions according to predicted texture of a first reference block. The first reference block is derived by Intra Prediction 810 according to a first Intra prediction mode or the first reference block is derived by Inter Prediction 812 according to a first motion vector (MV). Intra Prediction 810 generates the first reference block based on reconstructed video data of the current picture according to the first Intra prediction mode. Inter Prediction 812 performs motion estimation (ME) and motion compensation (MC) to provide the first reference block based on referencing video data from other picture or pictures according to the first MV. Some embodiments of splitting the current block according to the predicted texture of the first reference block comprise determining a dominate edge, classifying pixel intensities, or classifying pixel-based motions of the first reference block. Each partition of the current block is separately predicted either by the Intra Prediction 810 or Inter Prediction 812 to generated predicted regions. For example, all partitions of the current block are predicted by Inter Prediction 812, and each partition is predicted by reference block pointed by a motion vector. An embodiment blends the boundary of the predicted regions to reduce artifacts at the boundary. Intra Prediction 810 or Inter Prediction 812 supplies the predicted regions to Adder 816 to form residues by deducting corresponding pixel values of the predicted regions from the original data of the current block. The residues of the current block are further processed by Transformation (T) 818 followed by Quantization (Q) 820. The transformed and quantized residual signal is then encoded by Entropy Encoder 834 to form a video bitstream. The video bitstream is then packed with side information. The transformed and quantized residual signal of the current block is processed by Inverse Quantization (IQ) 822 and Inverse Transformation (IT) 824 to recover the prediction residues. As shown in FIG. 8, the residues are recovered by adding back to the predicted regions of the current block at Reconstruction (REC) 826 to produce reconstructed video data. The reconstructed video data may be stored in Reference Picture Buffer (Ref. Pict. Buffer) 832 and used for prediction of other pictures. The reconstructed video data from REC 826 may be subject to various impairments due to the encoding processing, consequently, In-loop Processing Filter (ILPF) 828 is applied to the reconstructed video data before storing in the Reference Picture Buffer 832 to further enhance picture quality. Syntax elements are provided to Entropy Encoder 834 for incorporation into the video bitstream.

A corresponding Video Decoder 900 for Video Encoder 800 of FIG. 8 is shown in FIG. 9. The video bitstream encoded by a video encoder is the input to Video Decoder 900 and is decoded by Entropy Decoder 910 to parse and recover the transformed and quantized residual signal and other system information. The decoding process of Decoder 900 is similar to the reconstruction loop at Encoder 800, except Decoder 900 only requires motion compensation prediction in Inter Prediction 914. A current block coded by predictor-based partition is decoded by Intra Prediction 912, Inter Prediction 914, or both Intra Prediction 912 and Inter Prediction 914. A first reference block determined by a first MV or a first Intra prediction is used to split the current block into multiple partitions. Each partition is separately compensated by either Intra Prediction 912 or Inter Prediction 914 to generate a compensated region. Mode Switch 916 selects a compensated region from Intra Prediction 912 or compensated region from Inter Prediction 914 according to decoded mode information. The transformed and quantized residual signal is recovered by Inverse Quantization (IQ) 920 and Inverse Transformation (IT) 922. The recovered residual signal is reconstructed by adding back the compensated regions of the current block in REC 918 to produce reconstructed video. The reconstructed video is further processed by In-loop Processing Filter (ILPF) 924 to generate final decoded video. If the currently decoded picture is a reference picture, the reconstructed video of the currently decoded picture is also stored in Ref. Pict. Buffer 928 for later pictures in decoding order.

Various components of Video Encoder 800 and Video Decoder 900 in FIG. 8 and FIG. 9 may be implemented by hardware components, one or more processors configured to execute program instructions stored in a memory, or a combination of hardware and processor. For example, a processor executes program instructions to control receiving of input video data. The processor is equipped with a single or multiple processing cores. In some examples, the processor executes program instructions to perform functions in some components in Encoder 800 and Decoder 900, and the memory electrically coupled with the processor is used to store the program instructions, information corresponding to the reconstructed images of blocks, and/or intermediate data during the encoding or decoding process. The memory in some embodiment includes a non-transitory computer readable medium, such as a semiconductor or solid-state memory, a random access memory (RAM), a read-only memory (ROM), a hard disk, an optical disk, or other suitable storage medium. The memory may also be a combination of two or more of the non-transitory computer readable medium listed above. As shown in FIGS. 8 and 9, Encoder 800 and Decoder 900 may be implemented in the same electronic device, so various functional components of Encoder 800 and Decoder 900 may be shared or reused if implemented in the same electronic device. For example, one or more of Reconstruction 826, Inverse Transformation 824, Inverse Quantization 822, In-loop Processing Filter 828, and Reference Picture Buffer 832 in FIG. 8 may also be used to function as Reconstruction 918, Inverse Transformation 922, Inverse Quantization 920, In-loop Processing Filter 924, and Reference Picture Buffer 928 in FIG. 9, respectively.

Embodiments of the video data processing method with predictor-based partition for video coding system may be implemented in a circuit integrated into a video compression chip or program code integrated into video compression software to perform the processing described above. For examples, determining of a current mode set for the current block may be realized in program code to be executed on a computer processor, a Digital Signal Processor (DSP), a microprocessor, or field programmable gate array (FPGA). These processors can be configured to perform particular tasks according to the invention, by executing machine-readable software code or firmware code that defines the particular methods embodied by the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of processing video data in a video coding system, wherein video data in a picture is partitioned into blocks, comprising:
receiving input data associated with a current block in a current picture;
determining a first reference block for the current block;
splitting the current block into a plurality of partitions according to predicted textures of the first reference block;
separately predicting or compensating each partition in the current block to generate predicted regions or compensated regions; and
encoding the current block according to the predicted regions and original data of the current block or decoding the current block by reconstructing the current block according to the compensated regions of the current block.

2. The method of claim 1, wherein the current block is predicted according to a prediction mode selected by a mode syntax.

3. The method of claim 2, wherein the mode syntax is signaled for the current block or the mode syntax is signaled for each partition of the current block.

4. The method of claim 1, wherein the first reference block used to split the current block is also used to predict one partition of the current block.

5. The method of claim 1, wherein the first reference block used to split the current block is determined according to a first motion vector (MV).

6. The method of claim 5, wherein the first MV is coded using Advance Motion Vector Prediction (AMVP) mode or Merge mode.

7. The method of claim 1, wherein the first reference block used to split the current block is determined according to a first intra prediction mode.

8. The method of claim 1, further comprises determining a second reference block for the current block, wherein one partition of the current block is predicted by the second reference block.

9. The method of claim 8, wherein the second reference block for the current block is determined according to a second MV.

10. The method of claim 9, wherein the second MV is coded using Advance Motion Vector Prediction (AMVP) mode or Merge mode.

11. (canceled)

12. The method of claim 1, wherein splitting the current block according to predicted textures of the first reference block comprises determining a dominate edge in the first reference block by applying an edge detection filter, wherein the dominate edge found in the first reference block is used to split the current block.

13. The method of claim 1, wherein splitting the current block according to predicted textures of the first reference block comprises determining pixel intensities of the first reference block and dividing the first reference block into clusters according to the pixel intensities, wherein the current block is partitioned according to the clusters of the first reference block.

14. The method of claim 1, wherein splitting the current block according to predicted textures of the first reference block comprises determining pixel-based motions of the first reference block and partitioning the current block according to the pixel-based motions of the first reference block.

15. The method of claim 1, wherein a first compensation region syntax is signaled to determine which partition of the current block is predicted by the first reference block.

16. The method of claim 1, where in a second syntax is signaled to determine which partition result is used if there are more than one partition results.

17. The method of claim 1, further comprises processing a boundary of the predicted regions or compensated regions to reduce artifacts at the boundary by modifying pixel values at the boundary of the predicted regions or compensated regions.

18. The method of claim 1, further comprises dividing the current block into N×N sub-blocks for reference MV storing when the current block is Inter predicted, storing a reference MV for each sub-block according to a predefined reference MV storing position, wherein one or more of the stored reference MVs are referenced by another block in the current picture or in another picture.

19. The method of claim 18, wherein the reference MV for each sub-block is stored further according to a first compensation region position flag.

20. An apparatus of processing video data in a video coding system,
wherein video data in a picture is partitioned into blocks, the apparatus comprising one or more electronic circuits configured for:
receiving input data associated with a current block in a current picture;
determining a first reference block for the current block;
splitting the current block into a plurality of partitions according to predicted textures of the first reference block;
separately predicting or compensating each partition in the current block to generate predicted regions or compensated regions; and
encoding the current block according to the predicted regions and original data of the current block or decoding the current block by reconstructing the current block according to the compensated regions of the current block.

21. A non-transitory computer readable medium storing program instruction causing a processing circuit of an apparatus to perform video processing method, and the method comprising:
receiving input data associated with a current block in a current picture;
determining a first reference block for the current block;
splitting the current block into a plurality of partitions according to predicted textures of the first reference block;
separately predicting or compensating each partition in the current block to generate predicted regions or compensated regions; and
encoding the current block according to the predicted regions and original data of the current block or decoding the current block by reconstructing the current block according to the compensated regions of the current block.
